(19) United States
(12) Patent Application Publication
(10) Pub. No.: US 2026/0254678 A1
(43) Pub. Date: Aug. 27, 2026

(54) METHOD FOR MULTIPLE ANTENNA TIME-OF-ARRIVAL-BASED RANGING VIA MULTI-TASK GROUP LEAST ABSOLUTE SHRINKAGE OPERATOR REGULARIZATION

(71) Applicant: ZaiNar, Inc., Redwood City, CA (US)

(72) Inventors: Philip Kratz, Redwood City, CA (US); Babak Azimi-Sadjadi, Redwood City, CA (US); Raquel Guerreiro Machado, Redwood City, CA (US); David Burgess, Redwood City, CA (US)

(21) Appl. No.: 19/566,048

(22) Filed: Mar. 13, 2026

Related U.S. Application Data
(63) Continuation-in-part of application No. 19/249,114, filed on Jun. 25, 2025.
(60) Provisional application No. 63/663,879, filed on Jun. 25, 2024.
(60) Provisional application No. 63/771,157, filed on Mar. 13, 2025.

(51) Int. Cl. H04L 25/02; H04B 17/12; H04B 17/21

(52) U.S. Cl. CPC H04L 25/0212; H04B 17/12; H04B 17/221

(57) ABSTRACT

A method includes: accessing a signal transmitted from a target device and received at a set of antenna elements; generating measurement data representing the signal; modeling the measurement data as combinations of channel responses corresponding to a set of propagation delay values to estimate channel coefficients indexed by the set of propagation delay values; jointly estimating channel coefficients for the set of antenna elements based on a residual difference, between the set of measurement data and a modeled signal generated from the channel coefficients, and combined magnitudes of groups of channel coefficients; identifying a subset of groups of channel coefficients characterized by non-zero values; isolating propagation delay values corresponding to the subset of groups of channel coefficients; and calculating a time-of-arrival estimate of the signal based on a selected propagation delay value in the subset of propagation delay values.

### CROSS-REFERENCE TO RELATED APPLICATIONS

This Application is a continuation-in-part of U.S. patent application Ser. No. 19/249,114, filed on 25 Jun. 2025, which claims the benefit of U.S. Provisional Application No. 63/663,879, filed on 25 Jun. 2024, each of which is incorporated in its entirety by this reference.

This Application claims the benefit of U.S. Provisional Application No. 63/771,157, filed on 13 Mar. 2025, which is incorporated in its entirety by this reference.

This Application is related to U.S. patent application Ser. No. 18/513,332, filed on 17 Nov. 2023, which is incorporated in its entirety by this reference.

### TECHNICAL FIELD

This invention relates generally to the field of network-based positioning and, more specifically, to a new and useful method for multiple antenna time-of-arrival-based ranging via multi-task group least absolute shrinkage operator (or “LASSO”) regularization within the field of network-based positioning.

### BRIEF DESCRIPTION OF THE FIGURES

FIGS. 1A and 1B are flowchart representations of a method;

FIGS. 2A and 2B are flowchart representations of one variation of the method; and

FIG. 3 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

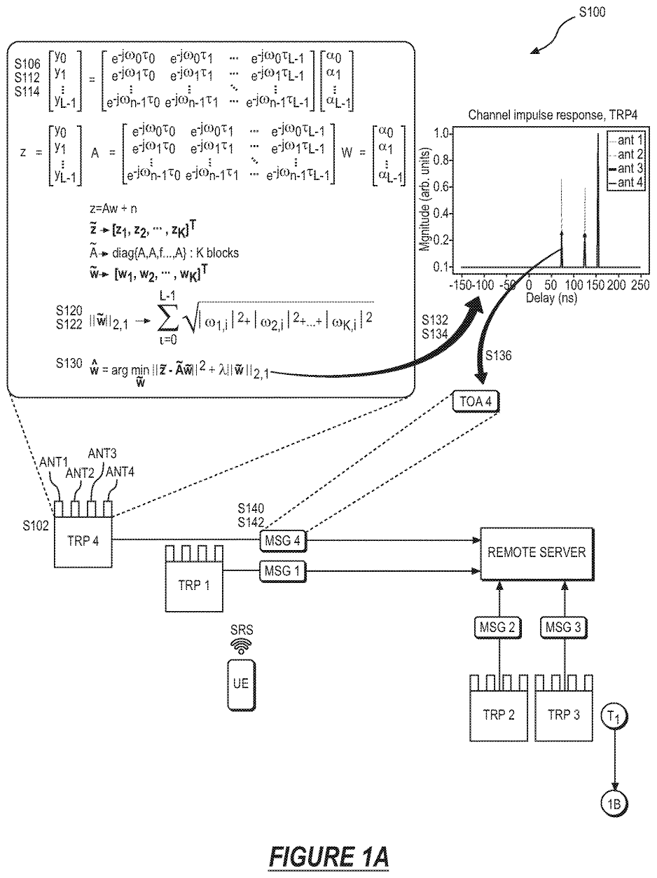

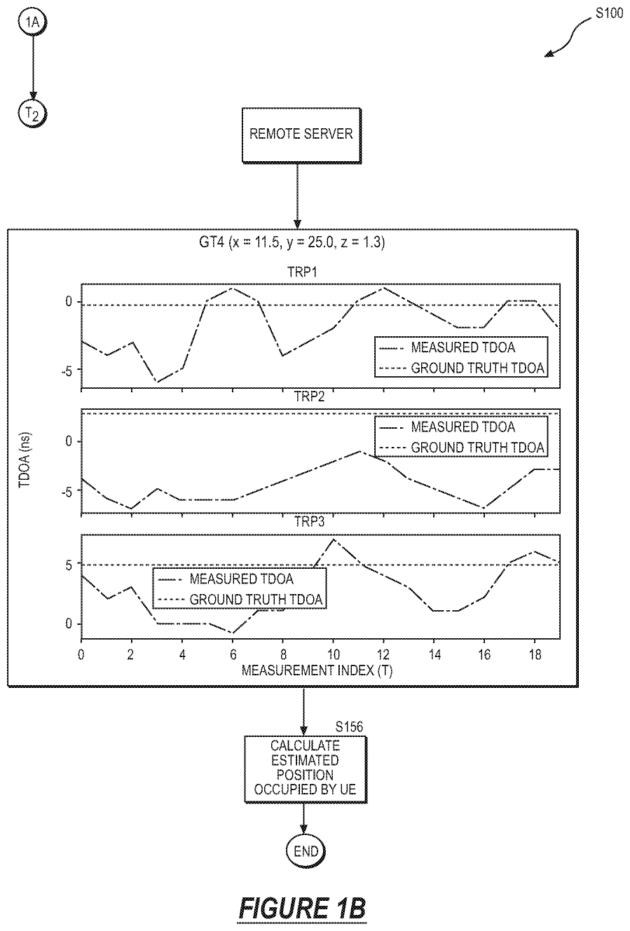

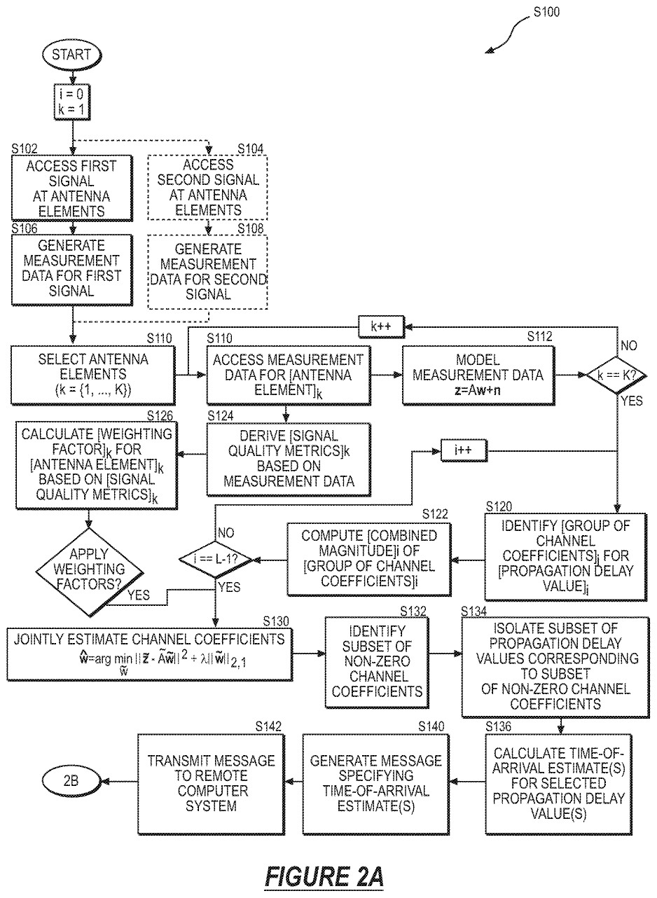

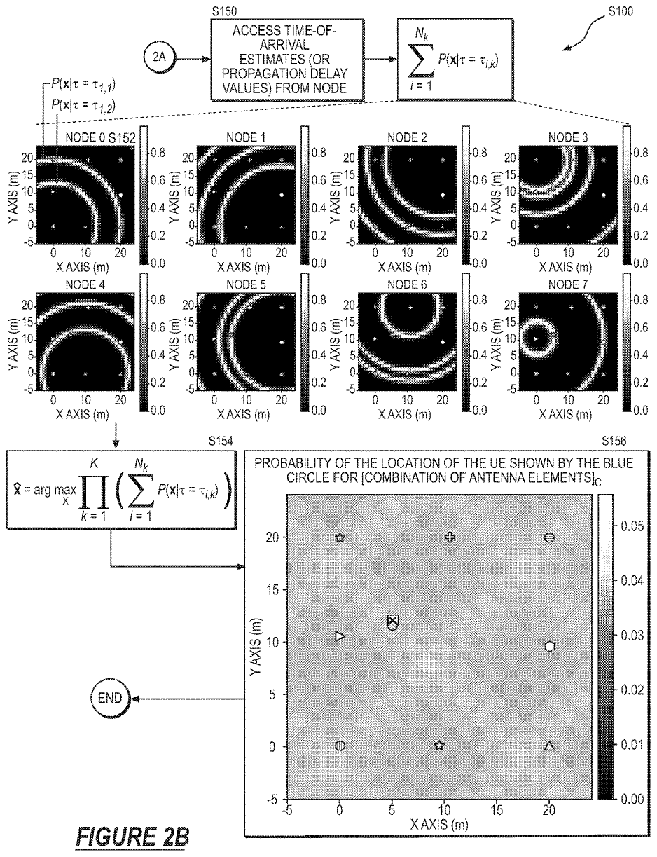

As shown in FIGS. 1A and 2A, a method S100 includes: accessing a ranging signal transmitted from a target device and received at a set of antenna elements of a node via a channel in Block S102; and generating a set of measurement data representing the ranging signal received at the set of antenna elements in Block S106. The ranging signal includes a set of multiplexed sub-signals characterized by a set of frequencies.

The method S100 also includes, for each antenna element in the set of antenna elements: accessing a subset of measurement data, in the set of measurement data, corresponding to the antenna element in Block S112; and modeling the subset of measurement data as a combination of channel responses corresponding to a set of propagation delay values to estimate channel coefficients, in a set of channel coefficients, indexed by the set of propagation delay values for the antenna element in Block S114.

The method S100 further includes, for each propagation delay value in the set of propagation delay values: identifying a group of channel coefficients, from the set of channel coefficients and in a set of groups of channel coefficients, indexed by the propagation delay value for the set of antenna elements in Block S120; and computing a combined magnitude of the group of channel coefficients in Block S122.

The method S100 also includes, in Block S130, jointly estimating the set of channel coefficients for the set of antenna elements based on: a residual difference between the set of measurement data and a modeled signal generated from the set of channel coefficients; and combined magnitudes of the set of groups of channel coefficients.

The method S100 further includes: identifying a first subset of groups of channel coefficients, in the set of groups of channel coefficients, characterized by non-zero values in Block S132; isolating a subset of propagation delay values, in the set of propagation delay values, corresponding to the first subset of groups of channel coefficients in Block S134; and calculating a time-of-arrival estimate for a line-of-sight component of the ranging signal based on a selected propagation delay value in the subset of propagation delay values in Block S136.

### 1.1 Variation: Multi-Task Group LASSO Over Multiple Signals

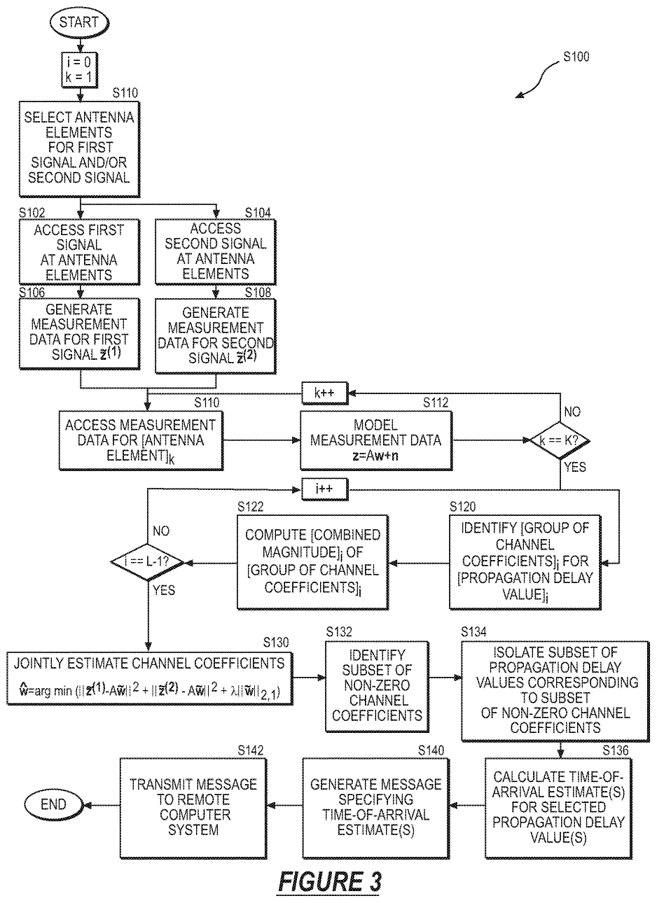

As shown in FIG. 3, one variation of the method S100 includes: accessing a first signal transmitted from a target device and received at a first subset of antenna elements in a set of antenna elements of a node in Block S102; accessing a second signal transmitted from the target device and received at a second subset of antenna elements in the set of antenna elements in Block S104; and generating a set of measurement data in Blocks S106 and S108. The set of measurement data includes: a first group of measurement data representing the first signal received at the first subset of antenna elements; and a second group of measurement data representing the second signal received at the second subset of antenna elements.

This variation of the method S100 also includes, for each antenna element in the set of antenna elements: accessing a subset of measurement data, in the set of measurement data, corresponding to the antenna element in Block S112; and modeling the subset of measurement data as a combination of channel responses corresponding to a set of propagation delay values to estimate channel coefficients, in a set of channel coefficients, indexed by the set of propagation delay values for the antenna element in Block S114.

This variation of the method S100 further includes, for each propagation delay value in the set of propagation delay values: identifying a group of channel coefficients, from the set of channel coefficients and in a set of groups of channel coefficients, indexed by the propagation delay value for the set of antenna elements in Block S120; and computing a combined magnitude of the group of channel coefficients in Block S122.

This variation of the method S100 also includes, in Block S130, jointly estimating the set of channel coefficients for the set of antenna elements based on: a first residual difference between the first group of measurement data and a modeled signal generated from the set of channel coefficients; a second residual difference between the second group of measurement data and the modeled signal; and combined magnitudes of the set of groups of channel coefficients.

This variation of the method S100 further includes: identifying a subset of groups of channel coefficients, in the set of groups of channel coefficients, characterized by non-zero values in Block S132; isolating the subset of propagation delay values corresponding to the subset of channel coefficients in Block S134; and calculating a time-of-arrival estimate for a line-of-sight component of the first signal based on a selected propagation delay value in the subset of propagation delay values in Block S136.

### 1.2 Variation: Measurement Data Model

As shown in FIGS. 1A and 2A, one variation of the method S100 includes: accessing a set of measurement data representing a signal transmitted from a target device and received at a set of antenna elements of a node in Block S106; and modeling the set of measurement data as combinations of channel responses corresponding to a set of propagation delay values to estimate a set of channel coefficients indexed by the set of propagation delay values for the set of antenna elements in Block S114.

This variation of the method S100 also includes, for each propagation delay value in the set of propagation delay values: identifying a group of channel coefficients, from the set of channel coefficients and in a set of groups of channel coefficients, indexed by the propagation delay value for the set of antenna elements in Block S120; and computing a combined magnitude of the group of channel coefficients in Block S122.

This variation of the method S100 further includes, in Block S130, jointly estimating the set of channel coefficients for the set of antenna elements based on: a residual difference between the set of measurement data and a modeled signal generated from the set of channel coefficients; and combined magnitudes of the set of groups of channel coefficients.

This variation of the method S100 also includes: identifying a subset of groups of channel coefficients, in the set of groups of channel coefficients, characterized by non-zero values in Block S132; isolating the subset of propagation delay values corresponding to the subset of groups of channel coefficients in Block S134; and calculating a time-of-arrival estimate of the signal based on a selected propagation delay value in the subset of propagation delay values in Block S136.

### 2. Applications

Generally, a system-including or interfacing with a target device (e.g., a user equipment, a mobile phone, a tablet, a laptop), a set of nodes (e.g., base stations, 5G gNodeBs, 5G transmission and reception points (or “TRPs”), 5G radio units (or “RUs”)), and a remote computer system (e.g., a remote server, a location management function)—can execute Blocks of the method S100: to transmit a ranging signal (e.g., a sounding reference signal) from the target device; to receive the ranging signal at multiple antenna elements of a node in the set of nodes; to generate measurement data representing the ranging signal received at the antenna elements; to model the measurement data according to a delay-domain channel model; to jointly estimate a sparse set of channel coefficients across the antenna elements by minimizing an objective function—including a data fidelity term and a group sparsity term—based on a multi-task group least absolute shrinkage operator (hereinafter “LASSO”) regularization technique; and to calculate a time-of-arrival estimate for a line-of-sight component of the ranging signal based on the sparse set of channel coefficients.

By implementing the multi-task group LASSO regularization technique, the system can execute Blocks of the method S100 to jointly enforce sparsity across groups of channel coefficients corresponding to common propagation delay values observed across the antenna elements. Rather than independently estimating a channel impulse response at each antenna element, the system can execute Blocks of the method S100: to identify a subset of propagation delay values that are consistently supported by measurement data across the antenna elements; and suppress delay components that are not jointly supported across these antenna elements, including components attributable to receiver noise, small-scale fading, and/or spurious reflections.

Accordingly, the system can isolate propagation delay values corresponding to significant multipath components (e.g., a line-of-sight component, common reflections from walls or the ground) that are common across the antenna elements of the node.

Therefore, the system can: improve robustness of propagation delay identification; increase accuracy of time-of-arrival estimation for localization of the target device; and/or reduce sensitivity to antenna-specific noise and fading effects.

### 2.1 Examples

In one example application, the system executes Blocks of the method S100: to receive a ranging signal—transmitted from an asset tag—at an antenna array of an access point (e.g., a multiple-input and multiple-output (or “MIMO”) access point) within a warehouse; to combine measurement data generated based on reception of the ranging signal at the antenna array; to isolate a set of significant propagation delays that are common across antennas of the antenna array based on the measurement data; and to estimate a time of arrival for the ranging signal based on the set of significant propagation delays in order to more accurately localize the asset tag within the warehouse exhibiting intense multipath characteristics due to geometries of the warehouse interior (e.g., floor, ceiling, walls) and a dynamic environment within this interior (e.g., pallets of goods being moved within the warehouse, forklifts traversing the warehouse floor), etc.

In another example application, the system executes Blocks of the method S100: to receive a ranging signal transmitted from a mobile device to a 5G-gNodeB device arranged on a rooftop of a building in an urban environment; to combine measurement data generated based on reception of the ranging signal at an antenna array of the 5G-gNodeB device; to isolate a set of significant propagation delays that are common across antennas of the antenna array based on the measurement data; and to estimate a time of arrival for the ranging signal based on the set of significant propagation delays in order to more accurately localize the mobile device within the urban environment exhibiting intense multipath characteristics due to geometries of the urban environment (e.g., street pavement, building walls, automobiles traversing the street).

### 3. System

Generally, as shown in FIG. 1A, the system can include and/or interface with: a set of nodes (e.g., base stations, 5G gNodeBs, 5G radio units, 5G transmission and reception points); and a set of devices (e.g., 5G user equipment, a mobile phone, a cellular modem, a laptop computer including a wireless network interface device). Additionally, the system can include and/or interface with a remote computer system (e.g., a remote server, a location management function).

In one implementation, the system includes a set of nodes (or “receivers”) arranged in a space.

In one example, the set of nodes can include a first gNodeB and a first transmission and reception point in a subset of transmission and reception points. The first includes a set of geographically co-located antennas (e.g., an antenna array(s) including a set of antenna elements with (or without) distinct polarization, multiple input multiple output (MIMO) arrays, beamforming arrays) that support transmission point and/or reception point functionality. Additionally, the first transmission and reception point can include a remote radio head.

In this example, the first gNodeB serves the subset of transmission and reception points, including the first transmission and reception point.

Additionally, the set of nodes can include a set of anchors representing reference positions. Positions occupied by the set of anchors can coincide with positions occupied by the first gNodeB and/or the subset of transmission and reception points (e.g., the first transmission and reception point).

Each node, in the set of nodes, occupies a known position in a reference coordinate system (e.g., a two-dimensional coordinate system, a three-dimensional coordinate system) representing the space. For example, the set of nodes can be uniformly distributed in space.

In this implementation, a node includes an antenna array including a set of antenna elements (e.g., four antenna elements, eight antenna elements).

More specifically, the node can include an antenna array defining the set of antenna elements k=1, . . . , K. Each antenna element is positioned at a displacement d (e.g., a uniform displacement, a non-uniform displacement, a known displacement, an unknown displacement) from each other antenna element in the antenna array. For example, the displacement d can correspond to one-half wavelength at a carrier frequency.

In another implementation, the system includes a target device (or “transmitter”) occupying a target (unknown) position in the reference coordinate system.

In this implementation, the system transmits (e.g., broadcasts) a signal (e.g., a ranging signal, a localization signal, a sounding reference signal) from the target device. For example, the target device can transmit the signal in response to a request (e.g., from a client system) for an estimated position of the target device.

More specifically, the target device can transmit the signal including a set of multiplexed sub-signals. Each multiplexed sub-signal in the set of multiplexed sub-signals (e.g., subcarrier signals) is characterized by a frequency in a set of frequencies (e.g., carrier frequencies).

In particular, the target device transmits the signal including a set of subcarrier signals, each subcarrier signal characterized by a subcarrier frequency, such as described in U.S. patent application Ser. No. 18/513,332.

In another implementation, a first node in the set of nodes: receives the signal at a first set of antenna elements of the first node via a channel; and calculates a first set of (reconstructed) channel impulse responses of the signal received at the first set of antenna elements.

More specifically, for each antenna element in the first set of antenna elements, the first node can: receive the signal at the antenna element; and generate frequency-domain measurement data corresponding to the signal. The first node can then execute multi-task group LASSO regularization to compute a first sparse solution to an objective function, the first sparse solution representing a first set of channel coefficients (delay-domain channel coefficients) corresponding to a channel impulse response—in the first set of channel impulse responses—of the signal received at each antenna element. The sparse solution identifies propagation delay values corresponding to significant multipath components of the signal across the first set of antenna elements.

In another implementation, the first node: calculates a first time-of-arrival estimate for a (candidate) line-of-sight component of the signal based on the first set of channel coefficients; and transmits the first time-of-arrival estimate to the remote computer system.

For example, the first node can: generate a message specifying the first time-of-arrival estimate for the line-of-sight component of the signal and/or the first set of channel coefficients; and transmit the message to the remote computer system.

Accordingly, the system can: characterize a set of channel impulse responses for a signal received at a set of antenna elements of a node; (non-coherently) group channel coefficients of the set of channel impulse responses; and compute a solution to a combined objective function to identify a common set of propagation delays—representing significant multipath components (e.g., a line-of-sight component, common reflections from walls or the ground) of the signal—for the set of antenna elements.

Therefore, the system can combine energy of the signal received at each antenna element of a node in order to: increase a signal-to-noise ratio of the signal; increase accuracy of a time-of-arrival estimate for the signal received at the node; and/or reduce error attributed to insignificant multipath components of the signal.

Each node in the set of nodes can repeat the foregoing methods and techniques: to receive the signal at a set of antenna elements of the node; to generate frequency-domain measurement data corresponding to the signal; to execute multi-task group LASSO regularization to compute a sparse solution to an objective function, the sparse solution representing a set of channel coefficients corresponding to a channel impulse response, in a set of channel impulse responses, of the signal received at the set of antenna elements; to calculate a time-of-arrival estimate(s) for a candidate line-of-sight component of the signal based on the set of channel coefficients; and to transmit the time-of-arrival estimate(s) to the remote computer system.

In another implementation, the remote computer system: receives a time-of-arrival estimate(s) from each node in the set of nodes; and calculates an estimated position, in the reference coordinate system, occupied by the target device. The remote computer system can return the estimated position of the target device (e.g., to the client system) responsive to the request.

### 4. Reference Signal

Generally, the system can: instruct a node (e.g., a serving node) to schedule the target device to transmit a signal (e.g., a sounding reference signal, a localization signal); select a set of configuration parameters for the signal; and instruct a set of nodes (e.g., the serving node, a subset of measuring nodes) to measure the signal according to the set of configuration parameters.

In one implementation, the system receives a request for an estimated position—in the reference coordinate system—occupied by the target device, such as from a client system (e.g., a client device, a client application).

In response to receiving the request, the system: selects a set of nodes (e.g., a node that serves the target device, a node proximal the target device); selects a set of configuration parameters (e.g., a bandwidth, a subcarrier spacing value, a set of antenna ports, a transmit power, a frequency position) for the signal; instructs (or schedules) the target device to transmit the signal according to the set of configuration parameters; and instructs the set of nodes to capture and record measurements of the signal according to the set of configuration parameters and/or a transaction identifier.

For example, the system can select the set of nodes including: a first node that serves the target device; a second node proximal the target device; a third node proximal the target device; and a fourth node proximal the target device.

In this example: the first node includes a first set of antenna elements (e.g., four antenna elements); the second node includes a second set of antenna elements; the third node includes a third set of antenna elements; and the fourth node includes a fourth set of antenna elements.

In another implementation, the target device transmits (e.g., broadcasts) the signal according to the set of configuration parameters.

For example, the target device can transmit the signal including a set of multiplexed sub-signals. Each multiplexed sub-signal in the set of multiplexed sub-signals is characterized by a carrier frequency in a set of carrier frequencies.

More specifically, the target device can: generate a signal x (t);

modulate the signal by a frequency ω=2πf (e.g., based on a carrier frequency hopping scheme); and transmit the signal through a channel h(t), wherein:

$$h ( t ) = {\sum }_{i = 1}^{N} {α}_{i} δ ( t - {τ}_{i} )$$

In particular, αᵢ corresponds to an amplitude and δ(t−τᵢ) is the Dirac delta distribution centered at the delay value τᵢ for the i^{th} delay term.

Accordingly, a node can: receive the signal at a set of antenna elements of the node; detect the signal exhibiting a set of characteristics corresponding to the set of configuration parameters; calculate a time-of-arrival estimate(s) of the signal received at the set of antenna elements; and record the time-of-arrival estimate(s) in association with the transaction identifier.

Therefore, by detecting the signal exhibiting the set of characteristics corresponding to the set of configuration parameters, the node can (implicitly) identify the signal based on the set of characteristics rather than based on a unique identifier associated with (or embedded within) the signal.

### 5. Multi-Task Group LASSO

The method S100 includes: accessing a set of measurement data representing a signal transmitted from a target device and received at a set of antenna elements of a node in Block S106; and modeling the set of measurement data as combinations of channel responses corresponding to a set of propagation delay values to estimate a set of channel coefficients indexed by the set of propagation delay values for the set of antenna elements in Block S114.

The method S100 includes, for each propagation delay value in the set of propagation delay values: identifying a group of channel coefficients, from the set of channel coefficients and in a set of groups of channel coefficients, indexed by the propagation delay value for the set of antenna elements in Block S120; and computing a combined magnitude of the group of channel coefficients in Block S122.

Block S130 of the method S100 recites jointly estimating the set of channel coefficients for the set of antenna elements based on: a residual difference between the set of measurement data and a modeled signal generated from the set of channel coefficients; and combined magnitudes of the set of groups of channel coefficients.

The method S100 includes: identifying a subset of groups of channel coefficients, in the set of groups of channel coefficients, characterized by non-zero values in Block S132; isolating the subset of propagation delay values corresponding to the subset of groups of channel coefficients in Block S134; and calculating a time-of-arrival estimate of the signal based on a selected propagation delay value in the subset of propagation delay values in Block S136.

Generally—in Blocks S102, S106, S112, S114, S120, S122, and S130—the system can: receive a signal at a set of antenna elements of a node; generate a set of measurement data corresponding to the signal; and compute a sparse solution to an objective function, the sparse solution representing channel coefficients corresponding to a channel impulse response of the signal received at each antenna element. The sparse solution identifies propagation delay values corresponding to significant multipath components of the signal across the set of antenna elements. The system can then calculate a time-of-arrival estimate(s) of the signal based on these propagation delay values.

Therefore, by jointly estimating channel coefficients across the set of antenna a elements and isolating propagation delay values corresponding to significant multipath components, the system can suppress noise and spurious delay estimates while reinforcing delay components that are consistently observed across these antenna elements in order to: more reliably distinguish true propagation paths from artifacts arising from noise, fading, or antenna-specific distortion; and more accurately generate time-of-arrival estimates in multipath environments.

### 5.1 Measurement Data and Representation

In one implementation, the system (e.g., the first node): accesses the signal transmitted from the target device and received at a set of antenna elements of a node via a channel in Block S102; and generates a set of measurement data representing the signal received at the set of antenna elements in Block S106. The signal includes a set of multiplexed sub-signals characterized by a set of frequencies.

More specifically, the first node can: receive the signal y(t) at an antenna element k of the first node, wherein y(t)=x(t)*h(t); and characterize a correlation function R(τ) based on a correlation of y(t) and x(t), wherein:

$${R}_{τ} = {\sum }_{l = 0}^{L - 1} {α}_{i} {e}^{- j ω {τ}_{i}} R ( τ - {τ}_{i} )$$

In this implementation, * represents convolution, τ₀ corresponds to a first propagation delay value (e.g., a first time of arrival) of a line-of-sight component of the signal, and τₗ corresponds to a second propagation delay value (e.g., a second time of arrival) of a multipath component—in a set of multipath components (e.g., L−1 multipath components)—of the signal.

The system can generate (or access) a subset of measurement data z—in a set of measurement data \tilde{z}—based on the (received) signal y(t), the set of measurement data representing spectral components of the signal corresponding to a set of carrier frequencies fᵢ=iδ_{f}, i=0, . . . , N−1 within a predefined bandwidth, wherein:

$$z = [ \begin{matrix}{y}_{0} \\ {y}_{1} \\ ⋰ \\ {y}_{N - 1}\end{matrix} ]$$

In this implementation, the subset of measurement data z represents frequency-domain measurement data generated based on the signal received at the antenna element k.

In particular, the system can define a time grid (e.g., a propagation delay grid) representing a set of propagation delay values and an increment δt between each propagation delay value in the set of propagation delay values. Based on the time grid, and for a set of carrier frequencies, the system can represent the signal (e.g., correlation measurements of the signal) as:

$$[ \begin{matrix}R ( {ω}_{0} ) \\ R ( {ω}_{1} ) \\ ⋰ \\ R ( {ω}_{N - 1} )\end{matrix} ] = [ \begin{matrix}{e}^{- j {ω}_{0} {τ}_{0}} R ( - {τ}_{0} ) & {e}^{- j {ω}_{0} {τ}_{1}} R ( - {τ}_{1} ) & ⋯ & {e}^{- j {ω}_{0} {τ}_{L - 1}} R ( - {τ}_{L - 1} ) \\ {e}^{- j {ω}_{1} {τ}_{0}} R ( - {τ}_{0} ) & {e}^{- j {ω}_{1} {τ}_{1}} R ( - {τ}_{1} ) & ⋯ & {e}^{- j {ω}_{1} {τ}_{L - 1}} R ( - {τ}_{L - 1} ) \\ ⋰ & ⋰ & ⋱ & ⋰ \\ {e}^{- j {ω}_{N - 1} {τ}_{0}} R ( - {τ}_{0} ) & {e}^{- j {ω}_{N - 1} {τ}_{1}} R ( - {τ}_{1} ) & ⋯ & {e}^{- j {ω}_{N - 1} {τ}_{L - 1}} R ( - {τ}_{L - 1} )\end{matrix} ] [ \begin{matrix}{α}_{0} \\ {α}_{1} \\ ⋰ \\ {α}_{L - 1}\end{matrix} ]$$

The system can define the set of carrier frequencies within a predefined bandwidth. In one example, the system defines the set of carrier frequencies within a first bandwidth of four megahertz for a narrowband ranging signal transmitted from a transmitter (e.g., the target device) to a receiver (e.g., the first node, the first antenna element). In another example, the system defines the set of carrier frequencies within a second bandwidth of 30 megahertz for a wideband ranging signal.

In another implementation, in Block S114, the system models the subset of measurement data as a combination of channel responses corresponding to the set of propagation delay values to estimate channel coefficients, in a set of channel coefficients, indexed by the set of propagation delay values for the antenna element k.

More specifically, the system can characterize a channel coefficient αᵢ based on variation responsive to correlation R(−τᵢ). For example, the system can define the channel coefficient αᵢ as:

$${α}_{i} ← R ( - {τ}_{i} ) {α}_{i}$$

In this implementation, the system represents the signal as:

$$[ \begin{matrix}{y}_{0} \\ {y}_{1} \\ ⋰ \\ {y}_{N - 1}\end{matrix} ] = [ \begin{matrix}{e}^{- j {ω}_{0} {τ}_{0}} & {e}^{- j {ω}_{0} {τ}_{1}} & ⋯ & {e}^{- j {ω}_{0} {τ}_{L - 1}} \\ {e}^{- j {ω}_{1} {τ}_{0}} & {e}^{- j {ω}_{1} {τ}_{1}} & ⋯ & {e}^{- j {ω}_{1} {τ}_{L - 1}} \\ ⋰ & ⋰ & ⋱ & ⋰ \\ {e}^{- j {ω}_{N - 1} {τ}_{0}} & {e}^{- j {ω}_{N - 1} {τ}_{1}} & ⋯ & {e}^{- j {ω}_{N - 1} {τ}_{L - 1}}\end{matrix} ] [ \begin{matrix}{α}_{0} \\ {α}_{1} \\ ⋰ \\ {α}_{L - 1}\end{matrix} ]$$

The system can define a complex noise vector n. Additionally, the system can represent the signal received at the antenna element as z=Aw+n, wherein:

$$z = [ \begin{matrix}{y}_{0} \\ {y}_{1} \\ ⋰ \\ {y}_{N - 1}\end{matrix} ]$$

$$A = [ \begin{matrix}{e}^{- j {ω}_{0} {τ}_{0}} & {e}^{- j {ω}_{0} {τ}_{1}} & ⋯ & {e}^{- j {ω}_{0} {τ}_{L - 1}} \\ {e}^{- j {ω}_{1} {τ}_{0}} & {e}^{- j {ω}_{1} {τ}_{1}} & ⋯ & {e}^{- j {ω}_{1} {τ}_{L - 1}} \\ ⋰ & ⋰ & ⋱ & ⋰ \\ {e}^{- j {ω}_{N - 1} {τ}_{0}} & {e}^{- j {ω}_{N - 1} {τ}_{1}} & ⋯ & {e}^{- j {ω}_{N - 1} {τ}_{L - 1}}\end{matrix} ] and$$

$$w = [ \begin{matrix}{α}_{0} \\ {α}_{1} \\ ⋰ \\ {α}_{L - 1}\end{matrix} ]$$

The system executes the foregoing methods and techniques for each antenna element k in the first set of antenna elements k=1, . . . , K to represent the signal received at the antenna element as zₖ=Awₖ+n in a set of measurement representations of the signal received at the first set of antenna elements, wherein wₖ corresponds to a channel coefficient vector, in a set of channel coefficient vectors (e.g., the set of channel coefficients), for the antenna element.

For example, the system can: access a first subset of measurement data z₁, in the set of measurement data \tilde{z}, representing the signal received at a first antenna element in the first set of antenna elements; and model the first subset of measurement data z₁ as a first combination of channel responses corresponding to the set of propagation delay values to estimate a first subset of channel coefficients w₁ indexed by the set of propagation delay values for the first antenna element, wherein:

$${z}_{1} = A {w}_{1} + n$$

In this example, the system can: access a second subset of measurement data z₂, in the set of measurement data \tilde{z}, representing the signal received at a second antenna element in the first set of antenna elements; and model the first subset of measurement data z₂ as a second combination of channel responses corresponding to the set of propagation delay values to estimate a second subset of channel coefficients w₂ indexed by the set of propagation delay values for the second antenna element, wherein:

$${z}_{2} = A {w}_{2} + n$$

In another implementation, the system accesses a block diagonal matrix Ã, wherein:

$$\tilde{A} \to diag \{ A , A , ⋯ , A \} : K blocks$$

In this implementation, the system: combines (or joins) the set of channel coefficient vectors into a first array \tilde{w} characterized by a first set of dimensions K·L; and combines (or joins) the set of measurement representations of the signal received at the first set of antenna elements into a second array \tilde{z} characterized by a second set of dimensions K·N, wherein:

$$\tilde{w} \to {[ {w}_{1} , {w}_{2} , ⋯ , {w}_{K} ]}^{T}$$

$$\tilde{z} \to {[ {z}_{1} , {z}_{2} , ⋯ , {z}_{K} ]}^{T}$$

$$\tilde{z} = \tilde{A} \tilde{w} + \tilde{n}$$

More specifically: the first array \tilde{w} represents the set of channel coefficients across the first set of antenna elements; and the second array \tilde{z} represents the set of measurement data corresponding to the signal received at the first set of antenna elements.

Accordingly, by generating frequency-domain measurement data corresponding to the signal received at each antenna element and modeling the measurement data according to a delay-domain representation, the system can: estimate channel coefficients indexed by propagation delay values for each antenna element; and evaluate propagation delay values that best correspond to the measurement data, thereby enabling the system to then identify significant propagation delay values corresponding to multipath components of the signal and calculate time-of-arrival estimates based on these significant propagation delay values.

### 5.2 Joint Channel Coefficient Estimation

Generally—in Blocks S120, S122, and S130—the system can compute a sparse solution ŵ for the following cost function:

$$\hat{w} = arg {min}_{\tilde{w}} {‖ \tilde{z} - \tilde{A} \tilde{w} ‖}^{2} + λ {‖ \tilde{w} ‖}_{2 , 1}$$

wherein:

$${‖ \tilde{w} ‖}_{2 , 1} \to {\sum }_{i = 0}^{L - 1} \sqrt{{\vert {w}_{1 , i} \vert}^{2} + {\vert {w}_{2 , i} \vert}^{2} + … + {\vert {w}_{K , i} \vert}^{2}}$$

More specifically, the system can jointly estimate the set of channel coefficients by executing a multi-task group LASSO regularization technique to compute the set of channel coefficients for the set of antenna elements based on: the residual difference between the set of measurement data and a modeled signal generated from the set of channel coefficients; and the combined magnitudes of the set of groups of channel coefficients.

Accordingly, by implementing the multi-task group LASSO regularization technique, the system can: group channel coefficients at each propagation delay index i; and combine magnitudes of these channel coefficients for the propagation delay index. The system can then compute a solution to the cost function that identifies propagation delay values corresponding to significant multipath components of the signal across the first set of antenna elements.

In one implementation, for each propagation delay value τᵢ in the set of propagation delay values, the system: identifies a group of channel coefficients, from the set of channel coefficients w and in a set of groups of channel coefficients, indexed by the propagation delay value τᵢ for the first set of antenna elements in Block S120; and computes a combined magnitude of the group of channel coefficients in Block S122.

More specifically, as described above, for each antenna element k in the first set of antenna elements k=1, . . . , K, the system can estimate a channel coefficient vector wₖ, each channel coefficient α_{i,k} corresponding to a propagation delay value τᵢ in the set of propagation delay values τ₀ . . . , τ_{L-1}, wherein:

$${w}_{k} = {[ {α}_{0 , k} , {α}_{1 , k} , ⋯ , {α}_{L - 1 , k} ]}^{T}$$

For each propagation delay value τᵢ, the system can identify a group of channel coefficients |α_{i,1}, α_{1,2}, . . . , α_{i,K}| corresponding to the propagation delay value τᵢ across the first set of antenna elements.

The system can then: characterize a combined magnitude associated with the group of channel coefficients based on magnitudes of channel coefficients in the group of channel coefficients. In particular, the system can compute a combined magnitude of the group of channel coefficients—corresponding to the propagation delay value τᵢ—based on a joint function of |α_{i,1}|, |α_{1,2}|, . . . , |α_{i,K}| (e.g., a magnitude of a first channel coefficient α_{i,1}, a magnitude of a second channel coefficient α_{i,2}).

For example, the system can identify a first group of channel coefficients {α_{0,1}, α_{0,2}, . . . , α_{0,K}} corresponding to the propagation delay value τ₀ across the first set of antenna elements. The first group of channel coefficients includes: a first channel coefficient α_{0,1} in a first subset of channel coefficients associated with the first antenna element; and a second channel coefficient α_{0,2} in the second subset of channel coefficients associated with the second antenna element.

In this example, the system can compute a first combined magnitude of the first group of channel coefficients—corresponding to the first propagation delay value τ₀—based on a joint function of |α_{0,1}|, |α_{0,2}|, . . . , |α_{0,K}| (e.g., a magnitude of a first channel coefficient α_{0,1}, a magnitude of a second channel coefficient α_{0,2}).

Therefore, by aggregating channel coefficients according to propagation delay values across antenna elements, the system can evaluate propagation delay values based on collective behavior across the first set of antenna elements rather than on a per-antenna basis.

In another implementation, in Block S130, the system jointly estimates the set of channel coefficients for the set of antenna elements based on: a residual difference between the set of measurement data and a modeled signal generated from the set of channel coefficients; and combined magnitudes of the set of groups of channel coefficients.

More specifically, the system can access (or define) an objective function J(\tilde{w}) including a first term (or a “data fidelity term”) representing the residual difference between the set of measurement data \tilde{z} and the modeled signal Ã\tilde{w}, and a second term (or a “sparsity term”) proportional to a sum of the combined magnitudes of the set of groups of channel coefficients over the set of propagation delay values, wherein:

$$J ( \tilde{w} ) = {‖ \tilde{z} - \tilde{A} \tilde{w} ‖}^{2} + λ {‖ \tilde{w} ‖}_{2 , 1}$$

For example, the first term corresponds to a squared norm of the residual difference between the set of measurement data \tilde{z} and the modeled signal Ã.

In this implementation, the system jointly estimates the set of channel coefficients w that yields a minimum value for the objective function J(\tilde{w}) to compute the sparse solution ŵ, wherein:

$$\hat{w} = arg {min}_{\tilde{w}} J ( \tilde{w} )$$

Because the objective function J(\tilde{w}) includes the second term proportional to the combined magnitudes of the set of groups of channel coefficients, the system can compute the sparse solution ŵ that yields a minimum value for (or minimizes) the objective function J(\tilde{w}) in order to promote solutions that limit a quantity of groups of channel coefficients that retain non-zero channel coefficients.

More specifically, the system can apply a sparsity constraint (λ∥\tilde{w}∥_{2,1}), across the set of groups of channel coefficients and based on the combined magnitudes of the set of groups of channel coefficients, that partitions the set of groups of channel coefficients into: a first subset of groups of channel coefficients in which channel coefficients—in each group of channel coefficients in the first subset of groups of channel coefficients—remain non-zero; and a second subset of groups of channel coefficients in which all channel coefficients, in each group of channel coefficients in the second subset of groups of channel coefficients, are set to zero across the first set of antenna elements.

In another implementation, the system: accesses (or identifies) the first subset of groups of channel coefficients, in the set of groups of channel coefficients, characterized by non-zero values in Block S132; and isolates a subset of propagation delay values, in the set of propagation delay values, corresponding to the first subset of channel coefficients in Block S134.

More specifically, the system can isolate the subset of propagation delay values: corresponding to the first subset of channel coefficients; and excluding propagation delay values corresponding to the second subset of groups of channel coefficients.

For example, the system can: identify the first subset of groups of channel coefficients including a first group of channel coefficients based on a first combined magnitude of the first group of channel coefficients corresponding to a first propagation delay value; and isolate the subset of propagation delay values including the first propagation delay value.

Accordingly, because the displacement d between antenna elements in the first set of antenna elements is sufficiently small (e.g., the displacement d between antenna elements falls below a threshold displacement), the system can calculate (or receive the signal experiencing) similar (e.g., nearly identical) channel impulse responses for antenna elements in the first set of antenna elements, thereby ensuring that times of arrival—of the signal received at the first set of antenna elements—are similar (e.g., differences between times of arrival falling below one nanosecond).

Therefore, the system can: model the set of representations of the signal received at the first set of antenna elements as representing a single channel (e.g., the same channel); isolate a common set of propagation delays—corresponding to a primary delay for a line-of-sight component of the signal and secondary delays for multipath reflections of the signal—for the signal received at the first set of antenna elements; and exclude insignificant propagation delays attributed to receiver noise and/or Rayleigh fading (e.g., reflections, diffraction, refraction).

### 5.3 Time-Of-Arrival Estimate Calculation

In one implementation, in Block S136, the system calculates a time-of-arrival estimate (e.g., for a candidate line-of-sight component) of the signal received at the first node based on a selected propagation delay value in the subset of propagation delay values.

For example, the system can: identify an earliest propagation delay value in the subset of propagation delay values as the selected propagation delay value; and calculate a time-of-arrival estimate for the line-of-sight component of the signal based on the earliest propagation delay value.

More specifically, the system can: identify the earliest propagation delay value in the subset of propagation delay values; access a combined magnitude of a group of channel coefficients corresponding to the earliest propagation delay value; and select the earliest propagation delay as the selected propagation delay value—corresponding to the line-of-sight component of the signal—in response to the combined magnitude exceeding a threshold magnitude.

In another implementation, the system: generates a message specifying the time-of-arrival estimate and/or the combined magnitude in Block S140; and transmits the message to the remote computer system for position estimation of the target device in Block S142.

Additionally or alternatively, the system can: calculate a set of time-of-arrival estimates for a set of candidate line-of-sight components of the signal; generate the message specifying the set of time-of-arrival estimates; and transmit the message to the remote computer system.

For example, the system can access a subset of combined magnitudes of the first subset of groups of channel coefficients corresponding to the subset of propagation delay values. The subset of combined magnitudes includes: a first combined magnitude of a first group of channel coefficients corresponding to a first propagation delay value; and a second combined magnitude of a second group of channel coefficients corresponding to a second propagation delay value.

In this example, based on the first combined magnitude and the second combined magnitude exceeding (e.g., all other) combined magnitudes in the subset of combined magnitudes, the system can: select the first propagation delay value for a first candidate line-of-sight component of the signal; and select the second propagation delay value for a second candidate line-of-sight component of the signal.

In this example, the system can then: calculate a first time-of-arrival estimate for the first candidate line-of-sight component of the signal based on the first propagation delay value; calculate a second time-of-arrival estimate for the second candidate line-of-sight component based on the second propagation delay value; generate a message including the first time-of-arrival estimate, the second time-of-arrival estimate, the first combined magnitude, and/or the second combined magnitude; and transmit the message to the remote computer system.

Therefore, by transmitting one or more time-of-arrival estimates—and associated combined magnitudes—to the remote computer system, the system can enable downstream position estimation processes to evaluate candidate propagation paths with associated confidence measures, thereby supporting more accurate localization of the target device, particularly in environments exhibiting dense multipath propagation.

### 5.4 Additional Nodes

The system can repeat the foregoing methods and techniques for each node in the set of nodes: to receive the signal at a set of antenna elements of the node; to generate a set of measurement data corresponding to the signal; to compute a sparse solution—that represents channel coefficients corresponding to a channel impulse response of the signal received at each antenna element—to an objective function, the sparse solution identifying propagation delay values corresponding to significant multipath components of the signal across the set of antenna elements; to calculate a time-of-arrival estimate(s) of the signal based on these propagation delay values; to generate a message specifying the time-of-arrival estimate(s); and to transmit the message to the remote computer system.

### 6. Position Estimation

Block S156 of the method S100 recites calculating an estimated position, in a reference coordinate system, occupied by the target device based on the time-of-arrival estimate.

Generally, in Block S156, the system can: access a set of messages from the set of nodes to the remote computer system, the set of messages representing time-of-arrival estimates of the signal-transmitted by the target device-received at antenna elements of the set of nodes; and calculate an estimated position of the target device based on these time-of-arrival estimates.

In one implementation, the system (e.g., the remote computer system) accesses a set of messages including: a first message specifying a first time-of-arrival estimate of (e.g., a line-of-sight component) the signal received at a first node in the set of nodes; a second message specifying a second time-of-arrival estimate of the signal received at a second node in the set of nodes; a third message specifying a third time-of-arrival estimate of the signal received at a third node in the set of nodes; and a fourth message specifying a fourth time-of-arrival estimate of the signal received at a fourth node in the set of nodes.

In this implementation, in Block S156, the system calculates an estimated position, in the reference coordinate system, occupied by the target device based on the first time-of-arrival estimate, the second time-of-arrival estimate, the third time-of-arrival estimate, and the fourth time-of-arrival estimate, such as via time-difference-of-arrival multilateration.

### 6.1 Maximum Likelihood Position Estimation

Generally, as shown in FIG. 2B, the system can characterize a position x, in the reference coordinate system, occupied by the target device based on a probability distribution (e.g., a joint probability distribution) for a first group of channel impulse responses M₁, M₂, . . . , M_{K} for the first combination of antenna elements (e.g., K antenna elements) according to (e.g., given) the position x of the target device, wherein:

$$\hat{x} = arg {max}_{x} P ( {M}_{1} , {M}_{2} , ⋯ , {M}_{K} \vert x ) \qquad ( Equation 1 )$$

More specifically, because receiver noise for these antenna elements is independent of each other, the system can characterize the probability distribution of the first group of channel impulse responses for the first combination of antenna elements given the position x of the target device as:

$$P ( {M}_{1} , {M}_{2} , ⋯ , {M}_{K} \vert x ) = {\prod }_{k = 1}^{K} P ( {M}_{k} \vert x )$$

The system can characterize a particular probability distribution for a particular channel impulse response given the position x of the target device as:

$$P ( {M}_{k} \vert x ) = \frac{P ( x \vert {M}_{k} ) P ( {M}_{k} )}{P ( x )}$$

Additionally, the system can calculate a probability distribution for the position x according to the particular channel impulse response, wherein:

$$P ( x \vert {M}_{k} ) = {\sum }_{i = 1}^{{N}_{k}} P ( x \vert τ = {τ}_{i , k} ) P ( τ = {τ}_{i , k} ) \qquad ( Equation 2 )$$

$$P ( x \vert {M}_{k} ) = p {\sum }_{i = 1}^{{N}_{k}} P ( x \vert τ = {τ}_{i , k} )$$

More specifically, the system can define p=P(τ=τ_{i,k}) for discrete random variable τ corresponding to a delay grid value in a set of delay grid values.

Accordingly, based on Equation 2, the system can characterize Equation 1 as:

$$\hat{x} = arg {max}_{x} P ( {M}_{1} , {M}_{2} , ⋯ , {M}_{K} \vert x )$$

$$\hat{x} = arg {max}_{x} {\prod }_{k = 1}^{K} P ( {M}_{k} \vert x )$$

$$\hat{x} = arg {max}_{x} C {\prod }_{k = 1}^{K} ( {\sum }_{i = 1}^{{N}_{k}} P ( x \vert τ = {τ}_{i , k} ) )$$

In particular, the remote computer system characterizes C as a combination of all probabilities (or probability distributions) independent of k. Therefore, the system can calculate the estimated position x occupied by the target device within the reference coordinate system, wherein:

$$\hat{x} = arg {max}_{x} {\prod }_{k = 1}^{K} ( {\sum }_{i = 1}^{{N}_{k}} P ( x \vert τ = {τ}_{i , k} ) )$$

In one implementation, in Block S150, the system (e.g., the remote computer system) accesses a first group of time-of-arrival estimates associated with a first node in the set of nodes. For example, the system can access a first message specifying the first group of time-of-arrival estimates including a first time-of-arrival estimate and a second time-of-arrival estimate.

In another implementation, in Block S152, the system generates a first probability map, in a set of probability maps, representing a first set of conditional probability masses for a set of positions in the reference coordinate system. Each conditional probability mass, in the first set of conditional probability masses, represents a probability mass for the target device occupying a position in the set of positions based on the group of time-of-arrival estimates.

In one variation, the system: derives a first group of propagation delay values based on the first group of time-of-arrival estimates; and generates the first probability map representing the first set of conditional probability masses for the set of positions in the reference coordinate system. Each conditional probability mass, in the first set of conditional probability masses, represents a probability mass for the target device occupying a position in the set of positions based on the first group of propagation delay values.

The system repeats the foregoing methods and techniques for each node in the set of nodes: to access a group of time-of-arrival estimates and/or a group of propagation delay values associated with the node; and to generate a probability map, in the set of probability maps, representing a set of conditional probability masses for the set of positions in the reference coordinate system based on the group of time-of-arrival estimates and/or the group of propagation delay values.

In another implementation, in Block S154, the system generates a composite probability map based on the set of probability maps. The composite probability map represents a composite set of conditional probability masses—for the set of positions of the reference coordinate system—based on a combination (e.g., a product) of a set of conditional probability masses for each probability map in the set of probability maps.

More specifically, the system can calculate the composite set of conditional probability masses by multiplying sets of conditional probability masses represented by the set of probability maps, the composite set of conditional probability masses represented as:

$${\prod }_{k = 1}^{K} ( {\sum }_{i = 1}^{{N}_{k}} P ( x \vert τ = {τ}_{i , k} ) )$$

For example, the remote computer system can generate a composite probability map based on the set of probability maps, including: the first probability map representing the first set of conditional probability masses; and conditional probability masses of probability maps (e.g., a second probability map representing a second set of conditional probability masses) in the set of probability maps.

In this example, the remote computer system can generate the composite probability map representing a third set of conditional probability masses based on a product of the first set of conditional probability masses and the second set of conditional probability masses.

In another implementation, in Block S156, the remote computer system calculates an estimated position \hat{x}—in the set of positions of the reference coordinate system—occupied by the target device based on the composite probability map. The estimated position \hat{x} is characterized by the greatest probability mass in the composite set of conditional probability masses.

Therefore, by executing the foregoing methods and techniques to implement maximum likelihood position estimation, the remote computer system can improve accuracy of position estimation—particularly when a time of arrival for a line-of-sight component of the signal is unknown (or uncertain)—while reducing computational costs.

### 7. Antenna Element Selection

In one variation, the system executes similar methods and techniques described above: to access a signal received at an antenna array including a first set of antenna elements and a second set of antenna elements in Block S102; to generate a first set of measurement data representing the signal received at the first set of antenna elements in Block S106; and to generate a second set of measurement data representing the signal received at the second set of antenna elements in Block S108.

In this variation, in Block S110, the system selects the first set of antenna elements from the antenna array based on signal quality metrics associated with the first set of measurement data and/or the second set of measurement data. Accordingly, the system can exclude (or bypass) the second set of antenna elements from the antenna array based on signal quality metrics associated with the second set of measurement data.

More specifically, the system can evaluate a signal quality metric corresponding to measurement data generated at each antenna element. The signal quality metric can represent: a signal-to-noise ratio associated with the measurement data; a noise floor estimate associated with the antenna element; and/or a confidence score derived from sparse channel coefficient estimation; etc.

The system can: select antenna elements associated with signal quality metrics exceeding a metric threshold value(s); and exclude antenna elements associated with signal quality metrics falling below the metric threshold value(s).

In this variation, the system then executes the foregoing methods and techniques: to compute a sparse solution—that represents channel coefficients corresponding to a channel impulse response of the signal received at each antenna element in the first set of antenna elements—to an objective function, the sparse solution identifying propagation delay values corresponding to significant multipath components of the signal across the set of antenna elements; to calculate a time-of-arrival estimate(s) of the signal based on these propagation delay values; to generate a message specifying the time-of-arrival estimate(s); and to transmit the message to the remote computer system.

In another variation, in Block S110, the system selects a subset of antenna elements, in a set of antenna elements of an antenna array of a node based on spatial arrangement of the set of antenna elements.

In one example, the system selects antenna elements located in alternating rows of the antenna array.

In another example, the system selects antenna elements located in alternating columns of the antenna array.

In another example, the system selects (or “decimates”) antenna elements at predefined spatial intervals in the antenna array.

In another example, the system selects antenna elements according to a predefined geometric configuration.

Accordingly, by selecting antenna elements according to a spatial arrangement of antenna elements, the system can reduce computational complexity of joint channel coefficient estimation and subsequent time-of-arrival estimation.

In another variation, the system dynamically selects different subsets of antenna elements for different time intervals.

For example, during a first time interval, the system can: select a first subset of antenna elements; and generate a first set of measurement data associated with the first subset of antenna elements. During a second time interval, the system can: select a second subset of antenna elements; and generate a second set of measurement data associated with the second subset of antenna elements. The system can then jointly estimate channel coefficient value based on the first set of measurement data and the second set of measurement data.

Therefore, by selecting a subset of antenna elements from the antenna array based on signal quality metrics and/or spatial arrangement, the system can improve robustness of sparse delay estimation while reducing computational burden.

### 8. Multi-Task Group LASSO Over Multiple Signals

In one variation, the system executes the foregoing methods and techniques: to access a first signal transmitted from the target device and received at a first set of antenna elements of the first node; to generate a first set of measurement data representing the first signal received at the set of antenna elements; and to model the first set of measurement data as combinations of channel responses corresponding to the set of propagation delay values to estimate channel coefficients, in a set of channel coefficients, indexed by the set of propagation delay values for the set of antenna elements.

In this variation, the system executes similar methods and techniques described above: to access a second signal transmitted from the target device and received at the first set of antenna elements of the first node; to generate a second set of measurement data representing the second signal received at the set of antenna elements; and to model the second set of measurement data as combinations of channel responses corresponding to the set of propagation delay values to estimate channel coefficients, in the set of channel coefficients, indexed by the set of propagation delay values for the set of antenna elements.

In this variation, because the first signal and the second signal traverse a corresponding (e.g., the same) channel within a selected time interval, the system combines the first set of measurement data and the second set of measurement data to jointly estimate the set of channel coefficients across the set of antenna elements.

More specifically, the system can access (or define) an objective function including: a first term representing a first residual difference between the first set of measurement data and a modeled signal generated from the set of channel coefficients; a second term representing a second residual difference between the second set of measurement data and the modeled signal; and a third term proportional to combined magnitudes of a set of groups of channel coefficients indexed by the set of propagation delay values. The system can then jointly estimate the set of channel coefficients that yield a minimum value for the objective function.

Accordingly, because the objective function incorporates residual differences corresponding to multiple signals, the system can compute a solution that is constrained to fit (or support) measurement data across both signals simultaneously, thereby reinforcing propagation delay values that are consistently supported across multiple signals while suppressing propagation delay values that are supported by (only) one signal due to noise or transient artifacts.

### 8.1 Example

In one example, as shown in FIG. 3, the system: selects a first subset of antenna elements, in a set of antenna elements of a node, for a first signal in Block S110; and selects a second subset of antenna elements, in the set of antenna elements, for a second signal. The system selects the first subset of antenna elements and/or the second subset of antenna elements based on spatial arrangement of the set of antenna elements.

In this example, the system: accesses the first signal transmitted from a target device and received at the first subset of antenna elements in Block S102; accesses the second signal transmitted from the target device and received at the second subset of antenna elements in Block S104; and generates a set of measurement data in Blocks S106 and S108. The set of measurement data includes: a first group of measurement data \tilde{z}⁽¹⁾ representing the first signal received at the first subset of antenna elements; and a second group of measurement data \tilde{z}⁽²⁾ representing the second signal received at the second subset of antenna elements.

For each antenna element in the set of antenna elements, the system: accesses a subset of measurement data, in the set of measurement data, corresponding to the antenna element in Block S112; and models the subset of measurement data as a combination of channel responses corresponding to a set of propagation delay values to estimate channel coefficients, in a set of channel coefficients, indexed by the set of propagation delay values for the antenna element in Block S114.

For each propagation delay value in the set of propagation delay values, the system: identifies a group of channel coefficients, from the set of channel coefficients and in a set of groups of channel coefficients, indexed by the propagation delay value for the set of antenna elements in Block S120; and computes a combined magnitude of the group of channel coefficients in Block S122.

In this example, the system accesses an objective function J(\tilde{w}) including: a first term representing a first residual difference between the first group of measurement data and a modeled signal generated from the set of channel coefficients; a second term representing a second residual difference between the second group of measurement data and the modeled signal; and a third term proportional to a sum, over the set of propagation delay values, of the combined magnitudes of the set of groups of channel coefficients, wherein:

$$J ( \tilde{w} ) = {‖ {\tilde{z}}^{( 1 )} - \tilde{A} \tilde{w} ‖}^{2} + {‖ {\tilde{z}}^{( 2 )} - \tilde{A} \tilde{w} ‖}^{2} + λ {‖ \tilde{w} ‖}_{2 , 1}$$

The system then jointly estimates the set of channel coefficients ŵ that yields a minimum value for the objective function in Block S130, wherein:

$$\hat{w} = arg {min}_{\tilde{w}} ( {‖ {\tilde{z}}^{( 1 )} - \tilde{A} \tilde{w} ‖}^{2} + {‖ {\tilde{z}}^{( 2 )} - \tilde{A} \tilde{w} ‖}^{2} + λ {‖ \tilde{w} ‖}_{2 , 1} )$$

In this example, the system: identifies a subset of groups of channel coefficients, in the set of groups of channel coefficients, characterized by non-zero values in Block S132; isolates the subset of propagation delay values corresponding to the subset of channel coefficients in Block S134; and calculates a time-of-arrival estimate—for a line-of-sight component of the first signal—based on a selected propagation delay value in the subset of propagation delay values in Block S136.

Accordingly, by selecting distinct subsets of antenna elements for different signals based on spatial arrangement and jointly estimating channel coefficients across these subsets of antenna elements, the system can leverage spatial diversity while reducing correlation effects within an antenna array including the set of antenna elements.

### 9. Weighted Multi-Task Group LASSO

In one variation, the system executes the foregoing methods and techniques: to access a signal transmitted from the target device and received at a set of antenna elements of a node; and to generate a set of measurement data representing the ranging signal received at the set of antenna elements.

For each antenna element in the set of antenna elements, the system executes the foregoing methods and techniques: to access a subset of measurement data, in the set of measurement data, corresponding to the antenna element; and to model the subset of measurement data as a combination of channel responses corresponding to a set of propagation delay values to estimate channel coefficients, in a set of channel coefficients, indexed by the set of propagation delay values for the antenna element.

In this variation, for each antenna element in the set of antenna elements, the system: derives a set of signal quality metrics associated with the subset of measurement data in Block S124; and calculates a weighting factor, in a set of weighting factors, for the antenna element based on the set of signal quality metrics in Block S126. The set of signal quality metrics can include: a signal-to-noise ratio associated with the subset of measurement data; a noise floor estimate associated with the antenna element; and/or a confidence score derived from channel coefficient estimation; etc.

In this variation, the system accesses (or defines) an objective function including: a first term representing a residual difference between the set of measurement data and a modeled signal generated from the set of channel coefficients; a second term proportional to combined magnitudes of the set of groups of channel coefficients; and the set of weighting factors.

More specifically, the system can apply the set of weighting factors to the first term and/or the second term to modulate influence of information derived from these antenna elements during joint channel coefficient estimation.

For antenna elements exhibiting higher signal quality (e.g., higher signal-to-noise ratio, lower noise variance, greater stability), the system: increases influence of residual differences associated with these antenna elements; and reduces sparsity penalties associated with channel coefficients corresponding to these antenna elements, thereby permitting these channel coefficients to remain non-zero when supported by reliable measurement data.

Conversely, for antenna elements exhibiting lower signal quality (e.g., lower signal-to-noise ratio, higher noise variance, instability), the system: reduces influence of residual differences associated with these antenna elements; and increases sparsity penalties associated with channel coefficients corresponding to these antenna elements, thereby encouraging suppression of these channel coefficients derived from unreliable measurement data.

In this variation, in Block S130, the system executes similar methods and techniques described above to jointly estimate the set of channel coefficients that yields a minimum value for the objective function.

Accordingly, by deriving weighting factors based on signal quality metrics associated with individual antenna elements and incorporating these weighting factors into the objective function, the system can adaptively control relative influence of antenna elements during joint channel coefficient estimation, thereby: increasing robustness of propagation delay identification; increasing accuracy of time-of-arrival estimation in dynamic environments; and/or mitigating degradation cause by noisy or unstable antenna elements.

### 10. Disclaimers

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive computer-readable a medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a ranging signal transmitted from a target device and received at a set of antenna elements of a node via a channel, the ranging signal comprising a set of multiplexed sub-signals characterized by a set of frequencies;
generating a set of measurement data representing the ranging signal received at the set of antenna elements;
for each antenna element in the set of antenna elements:
accessing a subset of measurement data, in the set of measurement data, corresponding to the antenna element; and
modeling the subset of measurement data as a combination of channel responses corresponding to a set of propagation delay values to estimate channel coefficients, in a set of channel coefficients, indexed by the set of propagation delay values for the antenna element;
for each propagation delay value in the set of propagation delay values:
identifying a group of channel coefficients, from the set of channel coefficients and in a set of groups of channel coefficients, indexed by the propagation delay value for the set of antenna elements; and
computing a combined magnitude of the group of channel coefficients;
jointly estimating the set of channel coefficients for the set of antenna elements based on:
a residual difference between the set of measurement data and a modeled signal generated from the set of channel coefficients; and
combined magnitudes of the set of groups of channel coefficients;
identifying a first subset of groups of channel coefficients, in the set of groups of channel coefficients, characterized by non-zero values;
isolating a subset of propagation delay values, in the set of propagation delay values, corresponding to the first subset of groups of channel coefficients; and
calculating a time-of-arrival estimate for a line-of-sight component of the ranging signal based on a selected propagation delay value in the subset of propagation delay values.

2. The method of claim 1:
wherein accessing the subset of measurement data for each antenna element in the set of antenna elements comprises:
accessing a first subset of measurement data, in the set of measurement data, representing the ranging signal received at a first antenna element in the set of antenna elements; and
accessing a second subset of measurement data, in the set of measurement data, representing the ranging signal received at a second antenna element in the set of antenna elements;
wherein modeling the subset of measurement data as the combination of channel responses for each antenna element in the set of antenna elements comprises:
modeling the first subset of measurement data as a first combination of channel responses corresponding to the set of propagation delay values to estimate a first subset of channel coefficients indexed by the set of propagation delay values for the first antenna element; and
modeling the second subset of measurement data as a second combination of channel responses corresponding to the set of propagation delay values to estimate a second subset of channel coefficients, indexed by the set of propagation delay values for the second antenna element; and
wherein identifying the group of channel coefficients for each propagation delay value in the set of propagation delay values comprises identifying a first group of channel coefficients indexed by a first propagation delay value in the set of propagation delay values for the set of antenna elements, the first group of channel coefficients comprising:
a first channel coefficient in the first subset of channel coefficients; and)
a second channel coefficient in the second subset of channel coefficients.

3. The method of claim 2, wherein computing the combined magnitude of the group of channel coefficients for each propagation delay value in the set of propagation delay values comprises computing a first combined magnitude of the first group of channel coefficients based on a joint function of:
a magnitude of the first channel coefficient; and
a magnitude of the second channel coefficient.

4. The method of claim 2:
wherein identifying the first subset of groups of channel coefficients comprises identifying the first subset of groups of channel coefficients based on a first combined magnitude of the first group of channel coefficients, the first subset of groups of channel coefficients comprising the first group of channel coefficients; and
wherein isolating the subset of propagation delay values comprises isolating the subset of propagation delay values corresponding to the first subset of groups of channel coefficients, the subset of propagation delay values comprising the first propagation delay value.

5. The method of claim 1, wherein jointly estimating the set of channel coefficients comprises applying a sparsity constraint, across the set of groups of channel coefficients, that partitions the set of groups of channel coefficients into:
the first subset of groups of channel coefficients in which channel coefficients, in each group of channel coefficients in the first subset of groups of channel coefficients, remain non-zero; and
a second subset of groups of channel coefficients in which all channel coefficients, in each group of channel coefficients in the second subset of groups of channel coefficients, are set to zero.

6. The method of claim 5, wherein isolating the subset of propagation delay values comprises isolating the subset of propagation delay values excluding propagation delay values corresponding to the second subset of groups of channel coefficients.

7. The method of claim 1, wherein jointly estimating the set of channel coefficients comprises jointly estimating the set of channel coefficients that yields a minimum value for an objective function comprising:
a first term representing the residual difference between the set of measurement data and the modeled signal; and
a second term proportional to a sum, over the set of propagation delay values, of the combined magnitudes of the set of groups of channel coefficients.

8. The method of claim 1, wherein jointly estimating the set of channel coefficients comprises executing a group least absolute shrinkage and selection operator to compute the set of channel coefficients for the set of antenna elements based on:
the residual difference between the set of measurement data and the modeled signal; and
the combined magnitudes of the set of groups of channel coefficients.

9. The method of claim 1:
wherein calculating the time-of-arrival estimate for the line-of-sight component of the ranging signal comprises:
identifying an earliest propagation delay value in the subset of propagation delay values as the selected propagation delay value; and
calculating the time-of-arrival estimate for the line-of-sight component of the ranging signal based on the earliest propagation delay value; and
further comprising calculating an estimated position, in a reference coordinate system, occupied by the target device based on the time-of-arrival estimate.

10. The method of claim 1:
wherein calculating the time-of-arrival estimate comprises:
calculating a first time-of-arrival estimate for a first candidate line-of-sight component of the ranging signal based on a first propagation delay value in the subset of propagation delay values; and
calculating a second time-of-arrival estimate for a second candidate line-of-sight component of the ranging signal based on a second propagation delay value in the subset of propagation delay values; and
further comprising:
generating a message specifying the first time-of-arrival estimate and the second time-of-arrival estimate; and
transmitting the message to a remote computer system for position estimation of the target device.

11. The method of claim 10:
wherein calculating the first time-of-arrival estimate comprises:
accessing a subset of combined magnitudes of a subset of groups of channel coefficients corresponding to the subset of propagation delay values, the subset of combined magnitudes comprising a first combined magnitude of a first group of channel coefficients corresponding to the first propagation delay value; and
selecting the first propagation delay value for the first candidate line-of-sight component based on the first combined magnitude exceeding combined magnitudes in the subset of combined magnitudes; and
wherein generating the message comprises generating the message comprising the first combined magnitude.

12. The method of claim 10, further comprising, at the remote computer system:
accessing a group of time-of-arrival estimates associated with the node, the group of times of arrival estimates comprising the first time-of-arrival estimate and the second time-of-arrival estimate:
generating a first probability map, in a set of probability maps, representing a first set of conditional probability masses for a set of positions in a reference coordinate system, each conditional probability mass in the first set of conditional probability masses representing a probability mass for the target device occupying a position in the set of positions based on the group of time-of-arrival estimates;
generating a composite probability map:
based on the set of probability maps; and
representing a second set of conditional probability masses for the set of positions based on a combination of the first set of conditional probability masses and conditional probability masses of probability maps in the set of probability maps; and
calculating an estimated position, in the reference coordinate system, occupied by the target device based on the composite probability map, the estimated position characterized by a greatest probability mass in the second set of conditional probability masses.

13. The method of claim 1:
wherein accessing the ranging signal comprises accessing the ranging signal received at an antenna array comprising:
the set of antenna elements; and
a second set of antenna elements of the node; and
further comprising:
generating a second set of measurement data representing the ranging signal received at the second set of antenna elements; and
selecting the set of antenna elements based on signal quality metrics associated with the first set of measurement data and the second set of measurement data, the set of antenna elements excluding the second set of antenna elements.

14. The method of claim 1:
further comprising:
accessing a second signal transmitted from the target device and received at the set of antenna elements via the channel;
generating a second set of measurement data representing the second ranging signal received at the set of antenna elements; and
modeling the second set of measurement data as combinations of channel responses corresponding to the set of propagation delay values to estimate channel coefficients, in the set of channel coefficients, indexed by the set of propagation delay values for the set of antenna elements; and
wherein jointly estimating the set of channel coefficients comprises jointly estimating the set of channel coefficients based on:
the residual difference between the set of measurement data and the modeled signal;
a second residual difference between the second set of measurement data and the modeled signal; and
the combined magnitudes of the set of groups of channel coefficients.

15. The method of claim 1:
further comprising, for each antenna element in the set of antenna elements:
deriving a set of signal quality metrics associated with the subset of measurement data; and
calculating a weighting factor, in a set of weighting factors, for the antenna element based on the set of signal quality metrics; and
wherein jointly estimating the set of channel coefficients comprises jointly estimating the set of channel coefficients based on:
the residual difference between the set of measurement data and the modeled signal;
the combined magnitudes of the set of groups of channel coefficients; and
the set of weighting factors.

16. A method comprising:
accessing a first signal transmitted from a target device and received at a first subset of antenna elements in a set of antenna elements of a node;
accessing a second signal transmitted from the target device and received at a second subset of antenna elements in the set of antenna elements;
generating a set of measurement data comprising:
a first group of measurement data representing the first signal received at the first subset of antenna elements; and
a second group of measurement data representing the second signal received at the second subset of antenna elements;
for each antenna element in the set of antenna elements:
accessing a subset of measurement data, in the set of measurement data, corresponding to the antenna element; and
modeling the subset of measurement data as a combination of channel responses corresponding to a set of propagation delay values to estimate channel coefficients, in a set of channel coefficients, indexed by the set of propagation delay values for the antenna element;
for each propagation delay value in the set of propagation delay values:
identifying a group of channel coefficients, from the set of channel coefficients and in a set of groups of channel coefficients, indexed by the propagation delay value for the set of antenna elements; and
computing a combined magnitude of the group of channel coefficients;
jointly estimating the set of channel coefficients for the set of antenna elements based on:
a first residual difference between the first group of measurement data and a modeled signal generated from the set of channel coefficients;
a second residual difference between the second group of measurement data and the modeled signal; and
combined magnitudes of the set of groups of channel coefficients;
identifying a subset of groups of channel coefficients, in the set of groups of channel coefficients, characterized by non-zero values;
isolating the subset of propagation delay values corresponding to the subset of channel coefficients; and
calculating a time-of-arrival estimate for a line-of-sight component of the first signal based on a selected propagation delay value in the subset of propagation delay values.

17. The method of claim 16, wherein jointly estimating the set of channel coefficients comprises estimating the set of channel coefficients that yields a minimum value for an objective function comprising:
a first term representing the first residual difference;
a second term representing the second residual difference; and
a third term proportional to a sum, over the set of propagation delay values, of the combined magnitudes of the set of groups of channel coefficients.

18. The method of claim 16, further comprising selecting the first subset of antenna elements for the first signal based on spatial arrangement of the set of antenna elements.

19. A method comprising:
accessing a set of measurement data representing a signal transmitted from a target device and received at a set of antenna elements of a node;
modeling the set of measurement data as combinations of channel responses corresponding to a set of propagation delay values to estimate a set of channel coefficients indexed by the set of propagation delay values for the set of antenna element;
for each propagation delay value in the set of propagation delay values:
identifying a group of channel coefficients, from the set of channel coefficients and in a set of groups of channel coefficients, indexed by the propagation delay value for the set of antenna elements; and
computing a combined magnitude of the group of channel C coefficients;
jointly estimating the set of channel coefficients for the set of antenna elements based on:
a residual difference between the set of measurement data and a modeled signal generated from the set of channel coefficients; and
combined magnitudes of the set of groups of channel coefficients;
identifying a subset of groups of channel coefficients, in the set of groups of channel coefficients, characterized by non-zero values;
isolating the subset of propagation delay values corresponding to the subset of groups of channel coefficients; and
calculating a time-of-arrival estimate of the signal based on a selected propagation delay value in the subset of propagation delay values.

20. The method of claim 19:
wherein jointly estimating the set of channel coefficients comprises applying a sparsity constraint, across the set of groups of channel coefficients and based on the combined magnitudes of the set of groups of channel coefficients, that partitions the set of groups of channel coefficients into
a first subset of groups of channel coefficients in which channel coefficients, in each group of channel coefficients in the first subset of groups of channel coefficients, remain non-zero; and
a second subset of groups of channel coefficients in which all channel coefficients, in each group of channel coefficients in the second subset of groups of channel coefficients, are set to zero; and
wherein identifying the subset of groups of channel coefficients comprises identifying the subset of groups of channel coefficients corresponding to the first subset of groups of channel coefficients.
